(19) United States
(12) Patent Application Publication
(10) Pub. No.: US 2023/0372850 A1
(43) Pub. Date: Nov. 23, 2023

(54) A FILTER MEDIA AND A PROCESS FOR PRODUCING THE SAME

(71) Applicant: Ahlstrom Oyj, Helsinki (FI)

(72) Inventors: David Alan TOPOLENSKI, Longmeadow, MA (US); Kent WILLIAMSON, Brentwood, TN (US); Andrew GOODBY, Sturgis, KY (US); Mike HADY, Mount Auburn, IL (US); Steven SHANNON, Lewisburg, KY (US); Jeffrey LADWIG, Overland Park, KS (US)

(21) Appl. No.: 18/262,858

(22) PCT Filed: Jan. 28, 2022
(86) PCT No.: PCT/FI2022/050056

§ 371 Date: Jul. 25, 2023

Related U.S. Application Data
(60) Provisional application No. 63/143,517, filed on Jan. 29, 2021.

(51) Int. Cl. B01D 39/18; B01D 39/16; B01D 46/52

(52) U.S. Cl. CPC B01D 39/18; B01D 39/1623; B01D 46/521; B01D 2239/1291; B01D 2239/1233; B01D 2239/086; B01D 2239/025; B01D 2239/10; B01D 2239/0636; B01D 2239/0663

(57) ABSTRACT

It is described herein a filter media comprising at least a first layer comprising first fibers and a second layer comprising second fibers. The first fibers may comprise synthetic fibers in an amount of at least 50 wt. % based on total weight of the fibers in the first layer. The second fibers may comprise cellulosic fibers in an amount of at least 30 wt. % based on total weight of the fibers in the second layer. The first layer may be joined to the second layer with an interface between the first layer and the second layer comprising a mixture of the first fibers and the second fibers such that a z-directional tensile strength (zdt) across the first layer and the second layer—in the absence of a secondary adhesive—is at least 0.5 psi. It is also described herein a process to produce such a filter media, and a filter element comprising such a filter media.

### BACKGROUND

Conventional multilayered filter media often comprise a meltblown layer laminated to a wetlaid layer. Each layer is comprised of fibers with the meltblown layer typically consisting of a single type of synthetic fiber—commonly polyester fibers, polyamide fibers, polypropylene fibers, or the like—and the wetlaid layer typically comprising cellulosic fibers that may be blended with other types of fibers.

The meltblown layer and the wetlaid layer in conventional multilayered filter media are assembled by laminating the layers together using an adhesive, pointbonding, thermobonding, or the like. For example, U.S. Pat. No. 8,142,535 B2 discloses a high dust holding capacity filter media produced by a wet process non-woven fibrous mat making machine equipped with two headboxes. The two layers are subjected to a single binder stream layer (i.e.—lamination) that helps in bonding the entire filter media together.

Lamination processes result in additional processing steps, which consume more energy and time as the adhesive is prepared and applied at the interface between the two layers—with each layer being manufactured separately prior to being joined—and allowed to cure. Additionally, lamination with an adhesive is known to diminish the resulting filter media's performance. As the adhesive is applied at the interface between the two layers, the adhesive occupies surface area and coats fibers of the media, thus reducing the surface area available for filtering fluids or holding dust rendering the media less effective for its intended filtration purposes.

The conventional methods of manufacturing multilayered filter media are also traditionally limited in the amount and types of fibers used in the different layers.

The need exists, therefore, for an improved multilayer filter media and a method of making the same, which demonstrates sufficient inter-layer bond strength without the use of a secondary adhesive (i.e.—without laminating). The need also exists for an improved multilayer filter media and a method of making the same which has better filtration performance and folding endurance.

### SUMMARY

Described herein is a filter media comprising a first layer and a second layer. The first layer comprises first fibers. The second layer comprises second fibers. The first fibers of the first layer may comprise synthetic fibers in an amount of at least 50 wt. % based on total weight of the fibers in the first layer. The second fibers of the second layer may comprise cellulosic fibers in an amount of at least 30 wt. % based on total weight of the fibers in the second layer.

The first layer may be joined to the second layer with an interface between the first layer and the second layer comprising a mixture of first fibers and the second fibers. A z-directional tensile strength (zdt) across the first layer and the second layer in the absence of a secondary adhesive may be at least 0.5 psi. In some embodiments the first layer may be joined to the second layer by physical entanglement between the first fibers and the second fibers.

In certain embodiments, the synthetic fibers may have an average fiber diameter of greater than 10 microns. The first fibers of the first layer, in some embodiments, may comprise the synthetic fibers in an amount of at least 70 wt. % based on total weight of the fibers in the first layer. In other embodiments, the first fibers of the first layer may comprise the synthetic fibers in an amount of at least 90 wt. % based on total weight of the fibers in the first layer.

In some embodiments, the second fibers of the second layer may comprise the cellulosic fibers in an amount of at least 50 wt. % based on total weight of the fibers in the second layer. In other embodiments the second fibers of the second layer may comprise the cellulosic fibers in an amount of at least 70 wt. % based on total weight of the fibers in the second layer.

In certain embodiments, the synthetic fibers may be selected from the group consisting of polyester fibers, PBT fibers, polyamide fibers, polypropylene fibers, polyvinyl alcohol fibers, and combinations thereof. In some embodiments, the synthetic fibers may be polyester fibers. The polyester fibers—when present—may be polyethylene terephthalate fibers. When used, the polyester fibers may be present in the first layer in an amount of at least 90 wt. % based on total weight of the fibers in the first layer.

In some embodiments, the first layer may comprise binder fibers. When present, the binder fibers may be present in an amount of no greater than 25 wt. % based on total weight of the fibers in the first layer. When used, the binder fibers may comprise polyvinyl alcohol fibers. In such embodiments, the polyvinyl alcohol fibers may be present in an amount of no greater than 10 wt. % based on total weight of the fibers in the first layer.

In certain embodiments, the second layer may comprise a second binder resin. When used, the second binder resin may be selected from the group consisting of phenolic binder resins, latex binder resins, and acrylic binder resins. The second binder resin—when used—may be present in the second layer in an amount of between 10 and 30 wt. % based on total weight of the second layer.

In some embodiments, the cellulosic fibers may be selected from the group consisting of kraft pulp fibers, sulfite pulp fibers, chemically treated fibers (E.g.—mercerized fibers), mechanically treated pulp fibers, chemi-thermo mechanically treated pulp fibers, non-woody cellulosic fibers, regenerated cellulosic fibers and combinations thereof.

In certain embodiments, the first layer may comprise no more than 20.0 wt. % based on total weight of the first fibers of the first layer of the cellulosic fibers. In other embodiments, the first layer may comprise no more than 10.0 wt. % based on total weight of the first fibers of the first layer of the cellulosic fibers.

In some embodiments, the second layer may comprise at least one groove.

In certain embodiments, a weight ratio between the first layer and the second layer may be in the range of between 20:80 and 80:20.

In some embodiments, the filter media may further comprise at least one subsequent layer comprising subsequent fibers selected from the group consisting of synthetic fibers, cellulosic fibers, and combinations thereof.

In certain embodiments, the filter media may have a hot oil burst strength of at least 20 psi after exposure to oil at 140° C. for 500 hours. In some embodiments, the filter media may have a filtration endurance index of at least 3.

In some embodiments, the filter media may not contain a mechanical support layer.

Also described herein is a filter element comprising a filter media of the type disclosed herein. In some embodiments of the filter element, the filter media may be pleated. In certain embodiments of the filter element, the filter media may be corrugated.

Further described herein is a process for producing a filter media of the type disclosed herein. The process may be a wet-laid dual headbox method comprising the steps of: forming a first fibrous slurry comprising the first fibers and a first solvent; forming a second fibrous slurry comprising the second fibers and a second solvent; transferring the first fibrous slurry to a first headbox zone while simultaneously transferring the second fibrous slurry to a second headbox zone; depositing the first fibrous slurry and the second fibrous slurry to a single continuous traveling forming belt wherein the first fibrous slurry is located on top of the second fibrous slurry; and applying a vacuum condition to the first fibrous slurry and the second fibrous slurry to remove at least a portion of the first solvent and/or the second solvent.

In some such embodiments, the first solvent may comprise water. In certain embodiments, the second solvent may comprise water.

In certain embodiments, the first headbox zone and the second headbox zone may comprise separate compartments of a single headbox. In other embodiments, the first headbox zone and the second headbox zone may comprise separate headboxes operating in tandem.

### BRIEF DESCRIPTION OF FIGURES

FIG. 1 depicts a side view of one embodiment of a filter media.

FIG. 2 depicts a side view of one embodiment of a filter media comprising a groove.

### DETAILED DESCRIPTION

Disclosed herein is a filter media. Also disclosed herein is a filter element comprising the filter media. The filter media is described below with reference to the Figures. Also disclosed herein is a process for producing the filter media. As described herein and in the claims, the following numbers refer to the following structures as noted in the Figures.
10 refers to a filter media.
100 refers to a first layer.
200 refers to a second layer.
210 refers to a groove.
300 refers to an interface.

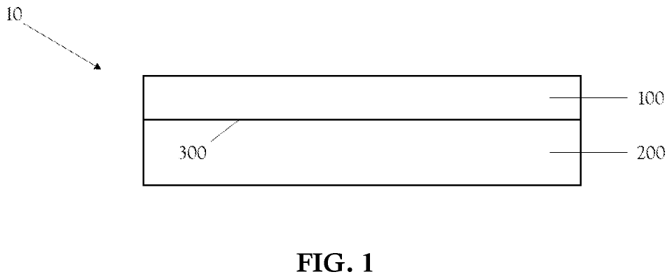

FIG. 1 depicts a side view of one embodiment of an invented filter media. As shown in FIG. 1, the filter media (10) may comprise a first layer (100) and a second layer (200). The first layer may be joined to the second layer with an interface (300) between the first layer and the second layer. The interface between the first layer and the second layer may comprise a mixture of the first fibers and the second fibers.

The interface (300) between the first layer (100) and the second layer (200) may be such that an inter-layer bonding strength between the first layer and the second layer exists in the absence of a secondary adhesive. This interlayer bonding strength may be quantified based on a z-directional tensile strength (zdt) across the first layer and the second layer in the absence of a secondary adhesive. The z-directional tensile strength (zdt) may be measured using the TAPPI T 541 method. Preferably the z-directional tensile strength (zdt) will be at least 0.5 psi with at least 0.75 psi being more preferred, and at least 1.0 psi being most preferred.

As used herein and in the claims, a secondary adhesive refers to an adhesive which is not a component—such as a binder resin or binder fibers—of the first layer (100) and/or the second layer (200). For clarity, one or both of the first layer and/or the second layer may comprise a binder resin and/or a binder fiber as disclosed herein, and a portion of the binder resin and/or binder fiber from the first layer and/or the second layer may be present at the interface (300). Such binder resins/binder fibers which are a component of the first layer and/or the second layer are not considered to be a secondary adhesive. While some amount of a secondary adhesive may be present in certain embodiments, the secondary adhesive is not considered necessary to produce the inter-layer bonding between the first layer and the second layer. Accordingly, the z-directional tensile strength (zdt) should be measured in the absence of any secondary adhesive.

The interface (300) between the first layer (100) and the second layer (200) may comprise a mixture of the first fibers and the second fibers. The joining of the first layer to the second layer at the interface may be such that a physical entanglement occurs between the first fibers and the second fibers.

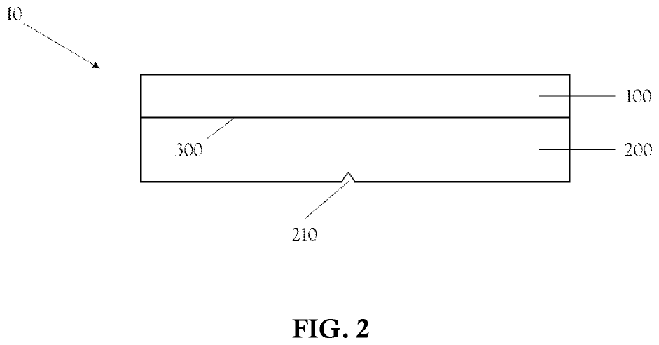

FIG. 2 depicts a side view of a separate embodiment of an invented filter media. As shown in FIG. 2, the second layer (200) of the filter media (10) may comprise a groove (210). Grooving (also referred to as corrugation) has the meaning commonly used in the art. Specifically, grooving may be defined as relating to a surface structure of alternate ridges or grooves. Several different corrugation techniques, any number of which are known in the art, may be utilized to form the groove(s)/corrugation(s) in the filter media. In some embodiments, grooves or corrugations may be utilized in embodiments where the filter media is pleated and utilized in a filter element. In such embodiments, the ridges or grooves may be applied in a direction perpendicular to the pleat direction. Doing so increases the effective surface area of the filter media without necessarily increasing the outer dimensions of the filter media.

The first layer (100) will comprise first fibers. Preferably, the first fibers of the first layer will comprise synthetic fibers. The synthetic fibers may be present in an amount of at least 50 wt. % based on total weight of the fibers in the first layer. Preferably, the synthetic fibers may be present in an amount of at least 70 wt. % based on total weight of the fibers in the first layer. More preferably, the synthetic fibers may be present in an amount of at least 90 wt. % based on total weight of the fibers in the first layer.

Synthetic fibers refer to fibers made from fiber-forming substances including polymers synthesized from chemical compounds. Such fibers may be produced by conventional melt-spinning, solution-spinning, solvent spinning, and like filament production techniques.

The synthetic fibers will have an average fiber diameter. The average diameter of the synthetic fibers may be determined—for example—by optically measuring the diameter of at least 50, preferably at least 100, and more preferably at least 200 synthetic fibers in the specific layer from pictures taken with a scanning electron microscope (SEM). A series of pictures of the layer are typically taken using an SEM with a large enough magnification so that the synthetic fibers are visible as light objects contrasting over a darker background. The mean value is then calculated to determine an average fiber diameter. Preferably, the average fiber diameter of the synthetic fibers will be greater than 10 microns. However, in some embodiments, the average fiber diameter of the synthetic fibers may be greater than 15 micron, greater than 20 micron, or greater than 25 micron.

The synthetic fibers may be selected from the group consisting of polyester fibers (e.g. polyalkylene terephthalates such as polyethylene terephthalate (PET), polybutylene terephthalate (PBT) and the like), polyamide fibers (nylon, e.g. nylon-t, nylon 6,6, nylon-6,12, and the like), polypropylene fibers, polyvinyl alcohol fibers, and combinations thereof. The preferred synthetic fibers will comprise polyester fibers. When present, the preferred polyester fibers are polyethylene terephthalate (PET) fibers. The polyester fibers—when present—may be present in the first layer in an amount of at least 90 wt. % based on total weight of the fibers in the first layer. Preferably, the polyester fibers—when present—will be present in the first layer in an amount of at least 94 wt. % based on total weight of the fibers in the first layer.

In some embodiments, the first fibers of the first layer may comprise first binder fibers. In this regard, a portion of the synthetic fibers may be binder fibers. When used, the binder fibers may be present in an amount of no greater than 50 wt. % based on the total weight of the synthetic fibers in the first layer, preferably no greater than 30 wt. % based on the total weight of the synthetic fibers in the first layer, and most preferably no greater than 20 wt. % based on the total weight of the synthetic fibers in the first layer. Typically the binder fibers—when present—will be present in a range selected from the group consisting of between 3 and 50 wt. %, between 3 and 30 wt. %, and between 3 and 20 wt. % based on the total weight of the synthetic fibers in the first layer.

In some embodiments, the first binder fibers may be present in an amount of no greater than 25 wt. % based on total weight of the fibers in the first layer. In some embodiments, the first binder fibers—when present—will be present in an amount of no greater than 20 wt. % based on total weight of the fibers in the first layer, no greater than 15 wt. % based on total weight of the fibers in the first layer, or no greater than 10 wt. % based on total weight of the fibers in the first layer.

Binder fibers may include thermoplastic binder fibers such as PET binder fibers or polyvinyl alcohol (PVOH) binder fibers. These binder fibers may have a lower melting point than the other synthetic fibers in the first layer, and may therefore act as a binding agent when softened or partially surface-melted during processing of the fibrous web of the first layer by heating. The binder fibers may also partially dissolve in the solvent used for the manufacturing process (i.e.—water) and become tacky. The tacky or softened binder fibers are therefore capable of internally binding the first fibers of the first layer by adhering to the first fibers and structurally strengthening the thus obtained fiber web. The average fiber length of these binder fibers may preferably be in the range of between about 2 mm and about 12 mm, such as about 6 mm.

A preferred example of the first binder fibers are polyvinyl alcohol (PVOH) binder fibers. When used, the polyvinyl alcohol fibers may be present in an amount of no greater than 10 wt. % based on total weight of the fibers in the first layer. In some embodiments, the polyvinyl alcohol fibers—when present—will be present in an amount of no greater than 7.5 wt. % based on total weight of the fibers in the first layer or no greater than 5.0 wt. % based on total weight of the fibers in the first layer.

Another example of the first binder fibers may be bicomponent thermoplastic fibers, which contain two thermoplastic polymer components, one of which has a lower melting point than the other. The lower melting point thermoplastic polymer component may act as a thermoplastic binding agent when softened or partially melted during processing of the fibrous web of the first layer (e.g.—during heating). The higher melting point thermoplastic polymer component may act as a structural material. The average fiber diameter of the bicomponent thermoplastic fibers may be in a range of about 2 to about 20 μm, such as 10 μm, while the average fiber length of these bicomponent thermoplastic fibers may be in a range of between about 2 mm and about 12 mm, such as about 6 mm.

In certain embodiments, the first layer may also comprise a first binder resin. In other embodiments, the first layer may not comprise any binder resin. When used, the first binder resin may be present in the first layer in an amount of between 10 and 30 wt. % based on total weight of the first layer. In some embodiments, the first binder resin—when present—will be present in the first layer in an amount of between 10 and 25 wt. % based on total weight of the first layer, between 10 and 20 wt. % based on total weight of the first layer, between 15 and 30 wt. % based on total weight of the first layer, between 15 and 25 wt. % based on total weight of the first layer, or between 20 and 30 wt. % based on total weight of the first layer.

Non-limiting examples of resins used as the first binder resin include polymers such as styrene acrylic, acrylic polyethylene vinyl chloride, styrene butadiene rubber, polystyrene acrylate, polyacrylates, polyvinyl chloride, polynitriles, polyvinyl acetate, polyvinyl alcohol derivatives, starch polymers, epoxy, phenolics, melamine-based resins. Preferred binder resins include phenolic binder resins, melamine-based binder resins, silicone binder resins, epoxy binder resins, acrylic binder resins (e.g.—vinyl acrylic latex resins), and the like. If present, the first fibers of the first layer may be coated or impregnated/saturated with the first binder resin.

The second layer (200) will comprise second fibers. Preferably, the second fibers of the second layer will comprise cellulosic fibers. The cellulosic fibers may be present in an amount of at least 30 wt. % based on total weight of the fibers in the second layer. Preferably, the cellulosic fibers may be present in an amount of at least 50 wt. % based on total weight of the fibers in the second layer. More preferably, the cellulosic fibers may be present in an amount of at least 70 wt. % based on total weight of the fibers in the second layer.

Cellulosic fibers refer to fibers composed of or derived from cellulose. The cellulosic fibers may be selected from the group consisting of kraft pulp fibers, sulfite pulp fibers, chemically treated fibers (E.g. mercerized fibers), mechanically treated pulp fibers, chemi-thermo mechanically treated pulp fibers, non-woody cellulosic fibers, regenerated cellulosic fibers and combinations thereof.

In certain embodiments, the second layer may also comprise a second binder resin. When used, the second binder resin may be present in the second layer in an amount of between 10 and 30 wt. % based on total weight of the second layer. In some embodiments, the second binder resin—when present—will be present in the second layer in an amount of between 10 and 25 wt. % based on total weight of the second layer, between 10 and 20 wt. % based on total weight of the second layer, between 15 and 30 wt. % based on total weight of the second layer, between 15 and 25 wt. % based on total weight of the second layer, or between 20 and 30 wt. % based on total weight of the second layer.

Non-limiting examples of resins used as the second binder resin include polymers such as styrene acrylic, acrylic polyethylene vinyl chloride, styrene butadiene rubber, polystyrene acrylate, polyacrylates, polyvinyl chloride, polynitriles, polyvinyl acetate, polyvinyl alcohol derivatives, starch polymers, epoxy, phenolics, melamine-based resins. Preferred binder resins include phenolic binder resins, melamine-based binder resins, silicone binder resins, epoxy binder resins, acrylic binder resins (e.g.—vinyl acrylic latex reins), and the like. If present, the second fibers of the second layer may be coated or impregnated/saturated with the second binder resin.

While the interface (300) between the first layer (100) and the second layer (200) may comprise a mixture of the first fibers and the second fibers, it is preferred that there be minimal or no co-mingling of first fibers and second fibers within the first layer and/or the second layer. By this it is meant that the first layer may comprise no more than 20.0 wt. % based on total weight of the fibers of the first layer of cellulosic fibers. In some embodiments, the first layer will comprise no more than 15.0 wt. % based on total weight of the fibers of the first layer of cellulosic fibers, no more than 10.0 wt. % based on total weight of the fibers of the first layer of cellulosic fibers, no more than 5.0 wt. % based on total weight of the fibers of the first layer of cellulosic fibers, or no more than 1.0 wt. % based on total weight of the fibers of the first layer of cellulosic fibers.

Similarly, the second layer may comprise no more than 20.0 wt. % based on total weight of the fibers of the second layer of synthetic fibers. In certain embodiments, the second layer will comprise no more than 15.0 wt. % based on total weight of the fibers of the second layer of synthetic fibers, no more than 10.0 wt. % based on total weight of the fibers of the second layer of synthetic fibers, no more than 5.0 wt. % based on total weight of the fibers of the second layer of synthetic fibers, or no more than 1.0 wt. % based on total weight of the fibers of the second layer of synthetic fibers.

It is not considered necessary for the first layer and the second layer to have the same or similar weight or thicknesses. In this respect, the first layer and the second layer may be described in terms of the weight ratio between the first layer and the second layer. The weight ratio between the first layer and the second layer may be in the range of between 20:80 and 80:20.

The filter media may have a filtration performance index (FR) of at least 3. The filtration performance index (FPᵢ) may be calculated according to the following formula:

FPᵢ=DHC×Fₑ

wherein DHC refers to the dirt holding capacity of the filter media (measured in mg/in²) per mil of thickness, and Fₑ refers to the filtration efficiency of the filter media (measured in %) at 20 μm. The dirt holding capacity (DHC) and filtration efficiency (Fₑ) may be measured according to ISO 4548-12 test standard for lube oil filtration using a Multipass system using ISO medium test dust as a contaminant with the media being in the form of a circular flat sheet with a sample diameter of 6.375 inches with a test flow of 0.5 L/min, particle injection flow of 250 mL/min, a BUGL (Basic Upstream Gravimetric Level) of 60 mg/L, and a face velocity of 3.624 in/min.

It is preferred, though not required, that the filter media does not contain a mechanical support layer. By a mechanical support layer it is meant an additional structural component which assists in maintaining the shape of the filter media during use. Examples of such mechanical support layers include plastic backings and wire mesh backings. As the filter media is preferred to not contain a mechanical support layer, the filter media may be referred to as self-supporting. By self-supporting it is meant that the filter media has sufficient strength/stiffness such that it can be utilized in a filter element without requiring additional supporting layers or backing structures.

In some embodiments, the filter media may comprise at least one subsequent layer. Each subsequent layer may comprise subsequent fibers with the subsequent fibers selected from the group consisting of synthetic fibers, cellulosic fibers, and combinations thereof. Each individual subsequent layer may be substantially similar, or identical to one of the first layer or the second layer. By substantially similar or identical it is meant that the subsequent layer may comprise fiber types, fiber dimensions, fiber amounts, binder fiber types, binder fiber amounts, binder resin types, and/or binder resin amounts the consistent with those disclosed herein for the first layer or the second layer.

In some embodiments, the subsequent fibers may be substantially different from the first layer or the second layer. In some embodiments, the subsequent fibers of the at least one subsequent layer may comprise nanofibers, such as synthetic nanofibers. Nanofibers are defined as fibers having a diameter less than 1 micron (1000 nm), particularly 50-350 nm, such as 100-300 nm. The nanofibers may be formed according to known methods such as via an electrospinning, force-spinning or meltblown process using suitable polymeric material. Nanofibers preferably are formed from thermoplastic polymeric materials including, but not limited to, polyether sulfone (PES), polyamide (PA) such as nylon, fluoropolymers (i.e. fluorocarbon based polymers) such as e.g. polyvinylidene fluoride (PVDF), polyacrylonitrile, polyamide.

In some embodiments, the subsequent layer comprising nanofibers may form a coating on the filter media. The basis weight or grammage of nanofiber coating may be too low to be measured but it is typically ˜0.5 gsm or more. Higher weight coatings can be made. For example, the nanofiber coating may use up to 5 gsm coating of PES nanofibers.

The nanofibers of the subsequent layer may be electrospun directly onto the fibrous web of the first layer and/or the second layer of the filter media to form a nanofiber coating. Preferably, the nanofibers of the subsequent layer are electrospun directly onto fibrous web of the first layer. An additional adhesive or glue layer may be used to adhere the nanofiber coating to the fibrous web. The composition of nanofiber-forming electrospun material may also include an adhesive that can be either coextruded as a miscible compound, i.e. either blended together prior to electrospinning, or electrospun simultaneously such that the adhesive is applied at the same time the nanofibers are being formed. The adhesive is a chemical compound that assists in holding the nanofibers of the nanofiber layer. The adhesive may preferably be used in amount up to 20% by weight, more preferably up to 10% by weight and most preferably up to 5% by weight, such as 0.1 to 5% by weight, based on the total weight of the composition of nanofiber-forming electrospun material.

The filter media may have a hot oil burst strength of at least 20 psi after exposure to oil at 140° C. for 500 hours. Hot oil burst strength refers to the pressure required to rupture a filter media sample after exposure to oil at a defined temperature for a defined period of time.

The filter media described herein may be incorporated into a filter element comprising the filter media. A filter element refers to a device or arrangement comprising the filter media disposed between a pair of end caps to form a hollow cylinder. Other shapes and arrangements may also be possible.

When incorporated into a filter element, the filter media may be subjected to any number of modifications. One example of such a modification may include pleating. Pleating (also known as folding) may be performed in stand-up pleats (also referred to as a zig-zag fold). Pleating processes are known in the art and may be carried out using a knife pleating machine and/or a rotary press. Pleating is commonly done to increase filtration surface area transversally to the direction of fluid flow. Another example of such a modification may include corrugating/grooving as described herein. Accordingly, it may be said that the filter media may be pleated, corrugated/grooved, or both when incorporated into a filter element.

The filter medium may be prepared in a continuous wet laid process. The process may first comprise forming a first fibrous slurry comprising the first fibers and a solvent. The process may also comprise forming a second fibrous slurry comprising the second fibers and a second solvent. The first solvent and the second solvent may each individually comprise water.

Once the first fibrous slurry and the second fibrous slurry are formed, the process may comprise transferring the first fibrous slurry to a first headbox zone while simultaneously transferring the second fibrous slurry to a second headbox zone. The first headbox zone and the second headbox zone may comprise separate compartments of a single headbox, or they may comprise separate headboxes operating in tandem.

Once the first fibrous slurry and the second fibrous slurry have been transferred to their respective headbox zones, the process may then proceed to depositing the first fibrous slurry and the second fibrous slurry to a single continuous traveling forming belt. As the fibrous slurries are deposited to the single continuous traveling forming belt, the first fibrous slurry is deposited on top of the second fibrous slurry such that the first fibrous slurry is located on top of the second fibrous slurry during subsequent processing steps.

The continuous traveling forming belt then advances the first fibrous slurry and the second fibrous slurry to a vacuum zone. Within the vacuum zone, a vacuum condition is applied to the first fibrous slurry and the second fibrous slurry from below the continuous traveling forming belt. The vacuum condition removes at least a portion of the first solvent and/or the second solvent.

Subsequent layers may be formed in a similar manner. For instance, when the subsequent layer(s) comprise a third layer, the process may comprise forming a third fibrous slurry comprising third fibers and a third solvent. Preferably, the third solvent may comprise water. The third fibrous slurry may then be transferred to a third headbox zone simultaneously with transferring the first fibrous slurry to the first headbox zone and transferring the second fibrous slurry to the second headbox zone. The third headbox zone may be a separate compartment—along with the first headbox zone and the second headbox zone—of a single headbox, or may comprise a separate headbox operating in tandem with the first headbox zone and the second headbox zone. The third fibrous slurry may then be deposited to the single continuous traveling forming belt. As the third fibrous slurry is deposited to the single continuous traveling forming belt, the third fibrous slurry is deposited on top of the first fibrous slurry such that the third fibrous slurry is located on top of the second fibrous slurry during subsequent processing steps. The continuous traveling forming belt then advances the first fibrous slurry, the second fibrous slurry, and the third fibrous slurry to the vacuum zone where a vacuum condition is applied to the first fibrous slurry, the second fibrous slurry, and the third fibrous slurry from below the continuous traveling forming belt to remove at least a portion of the first solvent, the second solvent, and/or the third solvent. This process may be repeated for each subsequent layer (i.e.—the fourth layer, the fifth layer, and so on).

It is preferred that the process for manufacturing the filter media does not include a lamination step. During lamination processes, a secondary adhesive may be applied at the interface between the layers, and subsequently allowed to cure to bond the layers to one another. The secondary adhesive used in the lamination process can diminish filtration performance by occupying surface area within the filtration media, thereby reducing the surface area available filtering fluids or holding dust. As a result of not including a lamination step in the manufacturing process, it may be said that—in a preferred embodiment of the invention—the first layer and the second layer (and any optional subsequent layers) are not laminated.

As stated above, it is preferred that the process for manufacturing the filter media does not include a lamination step with a secondary adhesive. However, in some embodiments the the filter media may be laminated to one or more additional layers such as lamination to a membrane formed of expanded polytetrafluoroethylene (ePTFE). The ePTFE membrane layer may be formed according to known methods such as billet forming, extrusion, calendaring, stretching and sintering using PTFE fine powder material. The ePTFE membrane has a basis weight of, e.g., about 1 to about 50 g/m², preferably about 1 to about 10 g/m². The ePTFE membrane may also have an air permeability of between about 5 to about 20 CFM and a bubble point between 50-200 inches of water column. The ePTFE membrane is typically laminated to a filter media which has a basis weight of between about 30 to 350 g/m². The resulting media typically has an air permeability of about 2 to 20 CFM and provides high efficiency, ranging between E10 to H14 as classified by EN 1822-1 standard. The resulting media is also preferably hydrophobic. The resulting media will have hydrophobic properties. The ePTFE membrane may be laminated to the filter media, preferably onto the first layer of the filter media, by any common means known in the art including adhesive lamination, thermal lamination, ultrasonic lamination, etc. For example, adhesive hot melt lamination may be used to bond the PTFE membrane to the base web. By way of example, a Minzell or IntaRoto brand name thermal laminator could be used to attach the ePTFE membrane layer to the first layer in the fibrous web. The speed of thermal lamination could for example range between 2 to 20 feet per minute.

### EXAMPLES

The following test methods were employed to obtain the data reported in the tables below.

Basis Weight: The basis weight is measured according to TAPPI Standard T 410 om-02 and reported in grams per square meter (gsm).

Hot Oil Burst Strength: Hot oil burst strength was measured after curing the filter media and placing it in hot oil (Mobil Oil 5W-30 Synthetic). The filter media was kept in the hot oil at 140° C. for 500 hours—representing the highest temperature that a typical internal combustion engine would achieve. After exposure to hot oil, the filter media is subjected to burst strength measurement according to ISO Standard 2758 (2014). A BF Perkins Mullen tester Serial No. 4104-75-497 120 psi Gauge Range available from Standex International Corporation, Chicopee, Massachusetts, U.S.A. was used to complete the burst strength measurement. Results are reported in pounds per square inch (psi).

Tear Strength: Tear strength was conducted according to TAPPI T424 standards using an Elmendorf type tear resistance tester.

Textest or Air Permeability: The air permeability of the media is measured according to TAPPI Standard T 251 cm-85 (“Air Permeability of Porous Paper, Fabric and Pulp Handshets) with 0.5 inch (2.7 mm) water differential using a Textest AG (model FX3300) and reported as the rate of the flow of air in cubic feet per square foot of sample area per minute (cfm/sf), sometimes referred to as cfm. Air permeability may also be referred to as air perm, porosity, Frazier, or Textest.

TMI Caliper and Groove Depth: The TMI Caliper and groove depth are measured according to TAPPI Standard T 411 om-05 using a Thwing Albert 89-100 Thickness Tester. Groove depth is the difference between the caliper of the flat sheet of media and the thickness of the sheet after corrugating the media.

The following materials were employed in the filter media examples reported in the tables below.
PET1: polyethylene terephthalate fiber having 0.5 denier and 0.25 inch length commercially available from, for example William Barnet & Son LLC.
PET2: polyethylene terephthalate fiber having 1.5 denier and 0.25 inch length commercially available from, for example William Barnet & Son LLC.
PET3: undrawn polyethylene terephthalate fiber having linear mass of 1.6 dtex and 5 mm length commercially available from, for example William Barnet & Son LLC.
PVOH: polyvinyl alcohol fiber having linear mass of 1.17 dtex and 4 mm fiber length commercially available from, for example Kuraray Co, Ltd.
EUC: Eucalyptus fiber commercially available from Eldorado Cellulose e Papel, Brazil.
NBSK: Northern Bleached Softwood Kraft fibers commercially available from International Paper.
SBSK: Southern Bleached Softwood Kraft fibers commercially available from International Paper.
C-06: Microglass fiber commercially available from Unifrax LLC
PBT1: polybutylene terephthalate fiber commercially available from MiniFIBERS, Inc.
MSF: mercerized softwood fiber—commercially available from Georgia-Pacific.
MTS: mechanically treated softwood fiber—commercially available from Georgia-Pacific.
Lyocell: regenerated cellulose fibers—commercially available from Lenzing AG.

The following filter media were prepared and tested for various properties with the test results reported in the tables below.

### Working Example 1 (WE1)

Working example 1 (sometimes referred to herein as “WE1”) was made on a wet-laid machine, and comprises two layers which are simultaneously laid down on a forming wire in the wet-laid machine. The filter media did not include a secondary adhesive at the interface. The fibers of the first layer and the second layer were mechanically entangled as a result of the forming process. The top layer (first layer) contained first fibers with 100 wt. % of the first fibers being synthetic fibers. Of the synthetic fibers, 47 wt. % were PET1, 47 wt. % were PET2, and 6 wt. % were PVOH binder fibers. The first layer was made to a targeted basis weight of 45.0 lbs/3,000 ft². The first layer did not contain any binder resin. The second layer contained second fibers with 94 wt. % of the second fibers being cellulosic fibers. Of the second fibers 49 wt. % were EUC cellulosic fibers, 45 wt. % NBSK cellulosic fibers, and 6 wt. % PET2 synthetic fibers. The second layer was made to a targeted basis weight of 55.0 lbs/3,000 ft². During manufacturing, the second layer was saturated with phenolic binder resin with the resulting second layer containing 80 wt. % second fibers and 20 wt. % binder resin.

### Working Example 2 (WE2)

Working example 2 (sometimes referred to herein as “WE2”) was made on a wet-laid machine, and comprises two layers which are simultaneously laid down on a forming wire in the wet-laid machine. The filter media did not include a secondary adhesive at the interface. The fibers of the first layer and the second layer were mechanically entangled as a result of the forming process. The top layer (first layer) contained first fibers with 100 wt. % of the first fibers being synthetic fibers. Of the synthetic fibers, 47 wt. % were PET1, 47 wt. % were PET2, and 6 wt. % were PVOH binder fibers. The first layer was made to a targeted basis weight of 50.2 lbs/3,000 ft². The first layer did not contain any binder resin. The second layer contained second fibers with 26 wt. % of the second fibers being cellulosic fibers. Of the second fibers 26 wt. % were NBSK cellulosic fibers, 20 wt. % were B-06 synthetic fibers, 20 wt. % were PET1 synthetic fibers, 30 wt. % were PET2 synthetic fibers, and 4 wt. % were PVOH synthetic binder fibers. The second layer was made to a targeted basis weight of 61.3 lbs/3,000 ft². During manufacturing, the second layer was saturated with phenolic binder resin with the resulting second layer containing 75 wt. % second fibers and 25 wt. % binder resin.

### Comparative Example 1 (CE1)

Comparative example 1 (sometimes referred to herein as “CE1”) was comprised of a two-layer laminated media. The top layer (first layer) contained a meltblown material containing first fibers. 100 wt. % of the first fibers were synthetic fibers in the form of PBT fibers. The first layer was made to a targeted basis weight of 44.0 lbs/3,000 ft². The bottom layer (second layer) was made on a wet-laid machine. The second layer contained second fibers with 100 wt. % of the second fibers being cellulosic fibers. Of the cellulosic fibers, 1 wt. % were SBSK fibers, 25 wt. % were MSF fibers, 3 wt. % were EUC fibers, and 71 wt. % were MTS fibers. During manufacturing the second layer was saturated with phenolic binder resin with the resulting second layer containing 77 wt. % second fibers and 23 wt. % binder resin. The first layer and the second layer were glued together with a secondary adhesive using a hot melt lamination technique.

### Comparative Example 2 (CE2)

Comparative example 2 (sometimes referred to herein as “CE2”) was comprised of a single-layer media made on a wet-laid machine. The single layer comprised fibers being a mixture of synthetic and cellulosic fibers. Of the fibers, 12 wt. % were EUC cellulosic fibers, 19 wt. % were MTS cellulosic fibers, 22 wt. % were SBSK cellulosic fibers, 3 wt. % were B-06 synthetic fibers, 23 wt. % were PET1 synthetic fibers, and 21 wt. % were PET2 synthetic fibers. The single-layer media was saturated with phenolic binder resin with the resulting single-layer media containing 82 wt. % fibers and 18 wt. % binder resin.

### Working Example 3 (WE3)

Working example 3 (sometimes referred to herein as “WE3”) was made on a wet-laid machine, and comprises two layers which are simultaneously laid down on a forming wire in the wet-laid machine. The filter media did not include a secondary adhesive at the interface. The fibers of the first layer and the second layer were mechanically entangled as a result of the forming process. The top layer (first layer) contained first fibers with 68 wt. % of the first fibers being synthetic fibers and the remaining 32 wt. % of the first fibers being Lyocell fibers. Of the first fibers, 20 wt. % were PET3, 32 wt. % were Lyocell42 wt. % were PET1, and 6 wt. % were PVOH binder fibers. The first layer was made to a targeted basis weight of 45.0 lbs/3,000 ft². The first layer did not contain any binder resin. The second layer contained second fibers with 100 wt. % of the second fibers being cellulosic fibers. Of the cellulosic fibers 9 wt. % were EUC, 4 wt. % were SBSK, and 87 wt. % were MSF. The second layer was made to a targeted basis weight of 55.0 lbs/3,000 ft². During manufacturing, the second layer was saturated with phenolic binder resin with the resulting second layer containing 80 wt. % second fibers and 20 wt. % binder resin.

### Working Example 4 (WE4)

Working example 4 (sometimes referred to herein as “WE4”) was made on a wet-laid machine, and comprises two layers which are simultaneously laid down on a forming wire in the wet-laid machine. The filter media did not include a secondary adhesive at the interface. The fibers of the first layer and the second layer were mechanically entangled as a result of the forming process. The top layer (first layer) contained first fibers with 100 wt. % of the first fibers being synthetic fibers. Of the first fibers, 47.7 wt. % were PET1, 47.7 wt. % were PET2, and 4.6 wt. % were PVOH binder fibers. The first layer was made to a targeted basis weight of 30.0 lbs/3,000 ft². The first layer did not contain any binder resin. The second layer contained second fibers with 31 wt. % of the second fibers being cellulosic fibers. Of the second fibers 31 wt. % were NBSK cellulosic fibers, 32 wt. % were C-06 synthetic fibers, 10 wt. % were PET1 synthetic fibers, 24 wt. % were PET2 synthetic fibers, and 3.0 wt. % were PVOH binder fibers. The second layer was made to a targeted basis weight of 61.3 lbs/3,000 ft². During manufacturing, the second layer was saturated with phenolic binder resin with the resulting second layer containing 75 wt. % second fibers and 25 wt. % binder resin.

Working Example 1, Working Example 2, Comparative Example 1, and Comparative Example 2 were tested for overall air permeability, tear strength, and hot oil burst strength. The results of these tests are summarized below in Table I.

TABLE I
Air Permeability, Tear Strength, and Hot Oil Burst
Strength of Working and Comparative Examples

| Property | Units | WE1 | WE2 | CE1 | CE2 |
|---|---|---|---|---|---|
| Saturated, Dried | lb/ | 134 | 135 | 115 | 117 |
| Basis Weight | 3,000 ft² | | | | |
| Textest | ft³/min. | 30 | 33 | 38 | 30 |
| TMI Caliper | mils | 37 | 40 | 40 | 36 |
| Groove Depth | mils | not | 9 | not | not |
| | | grooved | | grooved | grooved |
| z-directional tensile | psi | 1.3 | 1.7 | 2.3 | N/A |
| strength (zdt) | | | | | |
| Hot Oil Fold Endurance | number of | 218,498 | 43,687 | 21,332 | N/A |
| (fold endurance after ex- | fold cycles | | | | |
| posure to hot oil at | | | | | |
| 140° C. for 24 hours) | | | | | |
| Conditioned Fold Endur- | number of | 127,136 | 28,039 | 62,156 | N/A |
| ance (fold endurance af- | fold cycles | | | | |
| ter curing and placing in | | | | | |
| room conditions for | | | | | |
| 2 hours) | | | | | |
| Cured CD Tear Strength | grams of | 480 | 400 | 368 | 304 |
| | force | | | | |
| Hot Oil Burst Strength | psi | 33 | 33 | 10 | 28 |

The results show that the working examples achieve similar overall air permeability as measured by textest value when compared to the laminated two-layer comparative example (CE1) and the single-layer comparative example (CE2). Additionally, the working example demonstrate increased tear strength and hot oil burst strength when compared to both the two-layer comparative example (CE1) and the single-layer comparative example (CE2).

Working Example 1, Working Example 2, Comparative Example 1, and Comparative Example 2 were then tested for dirt holding capacity and filtration endurance index. The results of these tests are summarized below in Table II.

TABLE II
Dirt Holding Capacity and Filtration Endurance
Index of Working and Comparative Examples

| Multipass Test Data: | | | | | |
|---|---|---|---|---|---|
| Dirt Holding Capacity | | WE1 | WE2 | CE1 | CE2 |
| DHC per mil of caliper | mg/(in² * mil) | 3.6 | 5.7 | 2.2 | 3.1 |
| DHC | mg/in² | 132 | 228 | 86 | 112 |
| Efficiency @ Micron Size | | | | | |
| 5 μm | % | 31.7 | 13.8 | 46.7 | 33.2 |
| 10 μm | % | 60.2 | 34.1 | 85.8 | 63.3 |
| 15 μm | % | 84.1 | 68.4 | 97.7 | 85.8 |
| 20 μm | % | 94.8 | 88.4 | 99.3 | 95.7 |
| 25 μm | % | 99.1 | 9.74 | 99.5 | 99.4 |
| Filtration Performance | mg/(in² * mil)*% | 3.4 | 5.0 | 2.1 | 3.0 |
| Index | | | | | |

The results show that the working examples demonstrate increased dirt holding capacity with a similar filtration efficiency when compared to both the laminated two-layer comparative example (CE1) and the single-layer comparative example (CE2). The working examples also demonstrate a filtration endurance index greater than 3.0 as opposed to the comparative examples which demonstrate a maximum filtration endurance index of 3.0.

Finally, Working Example 3 and Working Example 4 were tested for overall air permeability, tear strength, hot oil burst strength, dirt holding capacity and filtration endurance index. The results of these tests are summarized in Table III and Table IV below.

TABLE III
Air Permeability, Tear Strength, and Hot
Oil Burst Strength of Working Examples

| Property | Units | WE3 | WE4 |
|---|---|---|---|
| Saturated, Dried Basis | lb/3,000 ft² | 128 | 140 |
| Weight | | | |
| Textest | ft³/min | 80 | 18 |
| TMI Caliper | mils | 32 | 42 |
| Groove Depth | mils | Not grooved | 8 |
| z-directional tensile | psi | 2.4 | 0.5 |
| strength | | | |
| Hot Oil Fold Endurance | number of fold | 74,362 | 11,320 |
| | cycles | | |
| Conditioned Fold | number of fold | 86,676 | 8,850 |
| Endurance | cycles | | |
| Cured CD Tear Strength | grams of force | 560 | 208 |
| 550-hr Hot Oil Burst | psi | 23 | 22 |
| Strength | | | |

TABLE IV
Dirt Holding Capacity and Filtration
Endurance Index of Working Examples

| Multipass Test Data | | | |
|---|---|---|---|
| Dirt Holding Capacity | Units | WE3 | WE4 |
| DHC per mil of caliper | mg/(in² * mil) | 9.1 | 3.5 |
| DHC | mg/in² | 290 | 146 |
| Efficiency @ Micron Size | | | |
| 5 μm | % | 7.1 | 42.4 |
| 10 μm | % | 11.7 | 75.7 |
| 15 μm | % | 24.6 | 94.9 |
| 20 μm | % | 40.7 | 99.1 |
| 25 μm | % | 70.0 | 99.9 |
| Filtration Performance Index | mg/(in² * mil)*% | 3.7 | 3.4 |

The results again demonstrate that the working examples exhibited good dirt holding capacity with a filtration endurance index greater than 3.0. The working examples also showed good tear strength and hot oil burst strength compared to comparative media of similar air permeability.

The filter media disclosed herein represent an improvement on the prior art. By manufacturing the filter media using the wet-laid dual headbox method disclosed herein the resulting multilayered filter media can be manufactured with sufficient inter-layer bond strength as demonstrated by hot oil burst strength and filtration endurance index. Additionally, the wet-laid dual headbox manufacturing method allows the filter media to be manufactured without the use of a secondary adhesive at the interface between the layers (i.e.—without laminating) such that the invented filter media does not reduce the surface area available for filtration or coat the fibers in adhesive. This avoids the reduction in filtration performance seen in traditional laminated multilayered filter media.

Additionally, the filter media disclosed herein represents an improvement on the prior art in that the invented multilayer filter media may comprise a blend of different fibers in one or more of the layers. This allows each layer to be customized with a blend of different fiber types with each different fiber type selected for different performance characteristics.

1. A filter media comprising:
a first layer comprising first fibers; and
a second layer comprising second fibers; and
wherein the first fibers of the first layer comprise synthetic fibers in an amount of at least 50 wt. % based on total weight of the fibers in the first layer, the second fibers of the second layer comprise cellulosic fibers in an amount of at least 30 wt. % based on total weight of the fibers in the second layer, the first layer is joined to the second layer with an interface between the first layer and the second layer comprising a mixture of the first fibers and the second fibers, a z-directional tensile strength (zdt) across the first layer and the second layer in the absence of a secondary adhesive is at least 0.5 psi.

2. The filter media of claim 1, wherein the first layer is joined to the second layer by physical entanglement between the first fibers and the second fibers.

3. The filter media of claim 1, wherein the synthetic fibers have an average fiber diameter of greater than 10 microns.

4. The filter media of claim 1, wherein the first fibers of the first layer comprise the synthetic fibers in an amount of at least 70 wt. % based on total weight of the fibers in the first layer.

5. The filter media of claim 1, wherein the first fibers of the first layer comprise the synthetic fibers in an amount of at least 90 wt. % based on total weight of the fibers in the first layer.

6. The filter media of claim 1, wherein the second fibers of the second layer comprise the cellulosic fibers in an amount of at least 50 wt. % based on total weight of the fibers in the second layer.

7. The filter media of claim 1, wherein the second fibers of the second layer comprise the cellulosic fibers in an amount of at least 70 wt. % based on total weight of the fibers in the second layer.

8. The filter media of claim 1, wherein the synthetic fibers are selected from the group consisting of polyester fibers, PBT fibers, polyamide fibers, polypropylene fibers, polyvinyl alcohol fibers, and combinations thereof.

9. The filter media of claim 8, wherein the synthetic fibers are polyester fibers.

10. The filter media of claim 9, wherein the polyester fibers are polyethylene terephthalate fibers.

11. The filter media of claim 9, wherein the polyester fibers are present in the first layer in an amount of at least 90 wt. % based on total weight of the fibers in the first layer.

12. The filter media of claim 9, wherein the first layer comprises binder fibers, and the binder fibers are present in an amount of no greater than 25 wt. % based on total weight of the fibers in the first layer.

13. The filter media of claim 12, wherein the binder fibers comprise polyvinyl alcohol fibers, and the polyvinyl alcohol fibers are present in an amount of no greater than 10 wt. % based on total weight of the fibers in the first layer.

14. The filter media of claim 1, wherein the second layer comprises a second binder resin.

15. The filter media of claim 14, wherein the second binder resin is selected from the group consisting of phenolic binder resins, latex binder resins, and acrylic binder resins.

16. The filter media of claim 13, wherein the second binder resin is present in the second layer in an amount of between 10 and 30 wt. % based on total weight of the second layer.

17. The filter media of claim 1, wherein the second layer comprises a second binder resin.

18. The filter media of claim 17, wherein the second binder resin is selected from the group consisting of phenolic binder resins, latex binder resins, and acrylic binder resins.

19. The filter media of claim 17, wherein the second binder resin is present in the second layer in an amount of between 10 and 30 wt. % based on total weight of the second layer.

20. The filter media of claim 1, wherein the cellulosic fibers are selected from the group consisting of kraft pulp fibers, sulfite pulp fibers, chemically treated fibers, mechanically treated pulp fibers, chemi-thermo mechanically treated pulp fibers, non-woody cellulosic fibers, regenerated cellulosic fibers, and combinations thereof.

21. The filter media of claim 1, wherein the first layer comprises no more than 20.0 wt. % based on total weight of the first fibers of the first layer of the cellulosic fibers.

22. The filter media of claim 1, wherein the first layer comprises no more than 10.0 wt. % based on total weight of the first fibers of the first layer of the cellulosic fibers.

23. The filter media of claim 1, wherein the second layer comprises at least one groove.

24. The filter media of claim 1, wherein a weight ratio between the first layer and the second layer is in the range of between 20:80 and 80:20.

25. The filter media of claim 1, further comprising at least one subsequent layer comprising subsequent fibers selected from the group consisting of synthetic fibers, cellulosic fibers, and combinations thereof.

26. The filter media of claim 25, wherein the subsequent fibers comprise synthetic nanofibers.

27. The filter media of claim 1, comprising at least one additional layer laminated to the filter media.

28. The filter media of claim 27, wherein the at least one additional layer is laminated to the first layer of the filter media.

29. The filter media of claim 27, wherein the at least one additional laminated layer comprises a membrane formed of expanded polytetrafluoroethylene (ePTFE).

30. The filter media of claim 1, having a hot oil burst strength of at least 20 psi after exposure to oil at 140° C. for 500 hours.

31. The filter media of claim 1, having a filtration endurance index of at least 3.

32. The filter media of any of claims 1 to 31, wherein the filter media does not contain a mechanical support layer.

33. A filter element comprising the filter media of claim 1.

34. The filter element of claim 33, wherein the filter media is pleated.

35. The filter element of claim 33, wherein the filter media is corrugated.

36. A process for producing the filter media of claim 1 comprising the steps of:
forming a first fibrous slurry comprising the first fibers and a first solvent;
forming a second fibrous slurry comprising the second fibers and a second solvent;
transferring the first fibrous slurry to a first headbox zone while simultaneously transferring the second fibrous slurry to a second headbox zone;
depositing the first fibrous slurry and the second fibrous slurry to a single continuous traveling forming belt wherein the first fibrous slurry is located on top of the second fibrous slurry; and
applying a vacuum condition to the first fibrous slurry and the second fibrous slurry to remove at least a portion of the first solvent and/or the second solvent.

37. The process of claim 36, wherein the first solvent comprises water.

38. The process of claim 36, wherein the second solvent comprises water.

39. The process of claim 36, wherein the first headbox zone and the second headbox zone comprise separate compartments of a single headbox.

40. The process of claim 36, wherein the first headbox zone and the second headbox zone comprise separate headboxes operating in tandem.

41. The filter media of claim 1, manufactured using a wet-laid dual headbox method.
